(19) United States
(12) Patent Application Publication
(10) Pub. No.: US 2022/0355286 A1
(43) Pub. Date: Nov. 10, 2022

(54) P-N HETEROJUNCTION COMPOSITE MATERIAL SUPPORTED ON SURFACE OF NICKEL FOAM, PREPARATION METHOD THEREFOR AND APPLICATION THEREOF

(71) Applicant: SOOCHOW UNIVERSITY, Suzhou (CN)

(72) Inventors: Jianmei LU, Suzhou (CN); Najun LI, Suzhou (CN)

(21) Appl. No.: 17/624,313

(22) PCT Filed: Dec. 31, 2020
(86) PCT No.: PCT/CN2020/142581

§ 371 Date: Dec. 31, 2021

(30) Foreign Application Priority Data
Apr. 20, 2020 (CN) 202010313573.5

(51) Int. Cl. B01J 35/00; C02F 1/72; B01J 23/745; B01J 23/75; B01J 23/755; B01J 37/02; B01J 37/04; B01J 37/10

(52) U.S. Cl. CPC B01J 35/0033; C02F 1/725; B01J 23/745; B01J 23/75; B01J 23/755; B01J 35/004; B01J 35/0006; B01J 37/0213; B01J 37/04; B01J 37/10; C02F 2305/10; C02F 2101/30

(57) ABSTRACT

Disclosed are a P—N heterojunction composite material supported on the surface of nickel foam, a preparation method therefor and the application thereof. The composite material is a supported catalyst which can be used to remove pollutants in water by means of photoelectrocatalysis. The method comprises firstly modifying, by means of a hydrothermal method, a layered nickel-iron bimetallic hydroxide nanosheet on the surface of clean nickel foam, and then modifying cobalt oxide nanowires on the surface of the layered nickel-iron bimetallic hydroxide nanosheet by means of a mixed solvent-thermal method, so as to obtain a P—N heterojunction catalyst composite material supported on the surface of nickel foam (Ni foam@NiFe-LDH/Co₃O₄). The composite material has a good response to visible light, which can greatly enhance the absorption and utilization of light, and is further beneficial to enhance the performance of the catalyst.

### FIELD OF THE INVENTION

The present invention relates to the field of nano composite materials and photoelectric catalysis technology, in particular to a method for preparing a P—N heterojunction composite material supported on the surface of nickel foam with two-dimensional layered nickel-iron bimetallic hydroxide nanosheet and one-dimensional cobalt oxide nanowires, and its application for effectively removing pollutants in water body by photoelectric catalysis.

### BACKGROUND OF THE INVENTION

In recent years, with the progress of science and technology and economic development, people's living standard has reached a new height, but it also brings problems such as energy shortage and environmental pollution. How to make rational use of existing resources to eliminate environmental pollution and protect the environment is a problem that needs attention at present. The photocatalysis technology with semiconductor materials as the core provides us with an ideal idea of pollution control. Its essence is to use cheap, clean and endless solar energy as energy, add catalysts to the pollution system, and produce photogenerated carriers when the semiconductor catalyst absorbs photons with energy equal to or greater than its band gap energy, then various kinds of active substances are formed. Among these active substances, those with oxidation properties can degrade organic pollutants and decompose them until mineralization, while those with reduction properties can be used to treat heavy metal ions in the environment. In this process, photocatalyst is excited by light to produce active substances and the reaction between active substances and environmental pollutants is the basis and key of the application of photocatalysis technology. However, at present, the catalytic efficiency of most photocatalysts is far from meeting the needs of practical application. Its main defects focus on the absorption and utilization range of light, the separation and migration of photogenerated carriers, and the stability and reuse of catalysts. Therefore, the current research focus on semiconductor photocatalytic technology mainly focuses on solving the above problems.

### SUMMARY OF THE INVENTION

The object of the invention is to provide a P—N heterojunction catalyst composite material supported on the surface of nickel foam (Ni foam@NiFe-LDH/Co₃O₄) and preparation method thereof, construct visible light responsive photocatalytic composites, and realize the effective removal of pollutants in water by photocatalysis. The invention constructs a load bearing P—N heterojunction composite material with visible light response. The built-in electric field inside the semiconductor composite material accelerates the migration rate of the photo generated carriers, thereby avoiding the recombination of the photo generated carriers and enhancing the catalytic activity. At the same time, the P—N heterojunction catalyst composite material supported on the surface of nickel foam (Ni foam@NiFe-LDH/Co₃O₄) can be directly used as a photoanode for photocatalytic reaction. Driven by an external electric field, it transfers photogenerated electrons to the counter electrode, which further enhances the separation of photogenerated carriers. In conclusion, this design not only improves the absorption and utilization of light, but also is conducive to the separation and migration of photogenerated carriers. At the same time, the way of photocatalysis can further improve the catalytic activity. In terms of catalytic performance, the composites prepared above show effective removal of pollutants, and because P—N heterojunction catalysts are loaded on the surface of the macro nickel foam, they exhibit convenient and good separation effect in the actual catalytic process.

In order to achieve the above object, the specific technical scheme of the invention is as following:

A P—N heterojunction composite material supported on the surface of nickel foam (Ni foam@NiFe-LDH/Co₃O₄) and preparation method thereof, comprising the following steps, modifying one-dimensional cobalt oxide nanowires on the surface of the layered nickel-iron bimetallic hydroxide nanosheet supported on the surface of nickel foam by means of a mixed solvent-thermal method to obtain the P—N heterojunction composite material supported on the surface of nickel foam(Ni foam@NiFe-LDH/Co₃O₄), which can be used as catalyst.

The present invention discloses a method for photoelectric catalytic purification of pollutants in water bodies, comprising the following steps: modifying one-dimensional cobalt oxide nanowires on the surface of the layered nickel-iron bimetallic hydroxide nanosheet supported on the surface of nickel foam by means of a mixed solvent-thermal method to obtain the P—N heterojunction composite material supported on the surface of nickel foam; adding the P—N heterojunction composite material supported on the surface of nickel foam into water containing pollutants, and performing photocatalytic and/or electrocatalysis to complete the purification of pollutants in the water.

In the invention, photocatalysis is visible photocatalysis; electrocatalysis is carried out at the electrochemical workstation. The two methods of catalytic operations are both conventional technologies. The inventive steps of the invention are to disclose the use of the P—N heterojunction composite material supported on the surface of nickel foam (Ni foam@NiFe-LDH/Co₃O₄) as a catalyst to purify pollutants in water.

The present invention discloses the application of the P—N heterojunction composite material supported on the surface of nickel foam (Ni foam@NiFe-LDH/Co₃O₄) as a catalyst in the purification of pollutants in water.

Pollutants in water can be inorganic or organic, such as chromium ion, oil, organic solvent, bisphenol compound, etc.

In the present invention, using nickel foam as the supporter, modifying layered nickel-iron bimetallic hydroxide nanosheet on the surface of nickel foam by means of a hydrothermal method; specifically, mixing the precursor solution with nickel foam and then reacting at 120-180° C. for 20-30 h by means of hydrothermal reaction method to obtain the layered nickel-iron bimetallic hydroxide nanosheet supported on the surface of nickel foam; the precursor solution consists of nickel salt, iron salt, water and urea, preferably, nickel salt is nickel nitrate hexahydrate and iron salt is iron nitrate hexahydrate; furthermore, in the precursor solution, the molar ratio of divalent metal ion Ni²⁺ to trivalent metal ion Fe³⁺ is 2:1, and the molar number of urea is 3.8-4.2 times of the sum of the molar numbers of divalent metal ion Ni²⁺ and trivalent metal ion Fe³⁺, preferably 4 times.

In the present invention, mixing the layered nickel-iron bimetallic hydroxide nanosheet with cobalt containing solution, and then hydrothermal reacting at 80-100° C. for 6-10 h and then heat treating to obtain the layered nickel-iron bimetallic hydroxide nanosheet supported on the surface of nickel foam, the cobalt containing solution is composed of water, ethanol, cobalt salt and urea, preferably, the cobalt salt is cobalt nitrate hexahydrate; and, the volume ratio of water to ethanol is 1:1 and molar ratio of urea to cobalt salt is 4:1, preferably, the concentration of cobalt salt is 0.003-0.008 g/mL, more preferably 0.004-0.005 g/mL; heat treatment is to keep temperature at 250° C. for 1.5-2.5 h in air, preferably 2 h.

In the present invention, macroscopic material nickel foam (Ni foam) is used as a carrier. First, modifying layered nickel-iron bimetallic hydroxide (NiFe-LDH) nanosheet on the surface of nickel foam by means of a hydrothermal method to obtain the layered nickel-iron bimetallic hydroxide nanosheet supported on the surface of nickel foam (Ni foam@NiFe-LDH), and then modifying one-dimensional cobalt oxide (Co₃O₄) nanowires on the surface of the layered nickel-iron bimetallic hydroxide nanosheet by means of a mixed solvent-thermal method to obtain a P—N heterojunction composite material supported on the surface of nickel foam (Ni foam@NiFe-LDH/Co₃O₄). Using the above composite material as photoanode, bisphenol A (BPA) and hexavalent chromium (Cr(VI)) are treated by photocatalysis. The P—N heterojunction composite material supported on the surface of nickel foam (Ni foam@NiFe-LDH/Co₃O₄) provided by the invention can effectively purify pollutants in water by photocatalysis.

In the invention, the preparation method of the P—N heterojunction composite material supported on the surface of nickel foam (Ni foam@NiFe-LDH/Co₃O₄) is as follows:

1) Preparation of layered nickel-iron bimetallic hydroxide precursor solution: firstly, deionized water, nickel nitrate hexahydrate and iron nitrate nine hydrate are successively added to a single mouth round bottom flask (the molar ratio of divalent metal ion Ni²⁺ to trivalent metal ion Fe³⁺ is 2:1, and the molar concentration of Fe³⁺ in deionized water is 0.1 mol/L), After stirring evenly, add urea (the feeding mole number of urea is 4 times the sum of the mole numbers of divalent and trivalent metal ions), stir evenly and reflux at 90-110° C. for 20-30 h to obtain the precursor solution of NiFe-LDH.

2) Preparation of layered nickel-iron bimetallic hydroxide nanosheet supported on the surface of nickel foam (Ni foam@NiFe-LDH): the invention synthesizes said layered nickel-iron bimetallic hydroxide nanosheet supported on the surface of nickel foam (Ni foam@NiFe-LDH) by means of a hydrothermal method. The surface clean nickel foam is placed in a high pressure kettle lined with polytetrafluoroethylene, and the precursor solution of layered nickel iron bimetallic hydroxide is added. Place the reactor in an oven with a preset temperature and conduct constant temperature hydrothermal reaction at 120-180° C. for 20-30 h. After the reaction is stopped, the heating is stopped. After the reactor is cooled to room temperature, the product is centrifugally separated and washed with deionized water for 3-5 times, and is dried in a 60° C. blast oven for 20-30 h, to obtain the layered nickel-iron bimetallic hydroxide nanosheet supported on the surface of nickel foam (Ni foam@NiFe-LDH).

3) Preparation P—N heterojunction catalyst composite material supported on the surface of nickel foam (Ni foam@NiFe-LDH/Co₃O₄): the invention synthesizes said P—N heterojunction catalyst composite material supported on the surface of nickel foam (Ni foam@NiFe-LDH/Co₃O₄) by means of a mixed solvent-thermal method. Firstly, deionized water, absolute ethanol, cobalt nitrate hexahydrate and urea (the volume ratio of deionized water to absolute ethanol is 1:1, and the molar ratio of urea to cobalt nitrate hexahydrate is 4:1) are successively added into the beaker, and the uniform mixed solution is obtained by ultrasonic dispersion. The layered nickel-iron bimetallic hydroxide nanosheet supported on the surface of nickel foam (Ni foam@NiFe-LDH) prepared in the above step 2) is put into a polytetrafluoroethylene lined autoclave, and a certain amount of the above mixed solution is added. Place the reactor in an oven with a preset temperature and conduct constant temperature hydrothermal reaction at 80-100° C. for 6-10 h. After the reaction is stopped, the heating is stopped. After the reactor is cooled to room temperature, the product is separated and washed with deionized water for 3-5 times. After drying, it is placed in a tubular furnace, and keep the temperature at 250° C. under air for 2 h, the heating rate is 2-5° C./min, to obtain the P—N heterojunction catalyst composite material supported on the surface of nickel foam (Ni foam@NiFe-LDH/Co₃O₄).

Advantages of the invention:

1. The P—N heterojunction catalyst composite material supported on the surface of nickel foam (Ni foam@NiFe-LDH/Co₃O₄) disclosed in the invention is a visible light photocatalytic composite with a wide range of light response.

2. The P—N heterojunction in the P—N heterojunction catalyst composite material supported on the surface of nickel foam (Ni foam@NiFe-LDH/Co₃O₄) disclosed in the invention can provide additional electric field to accelerate electron hole migration, so as to improve the catalytic performance.

3. In the P—N heterojunction in the P—N heterojunction catalyst composite material supported on the surface of nickel foam (Ni foam@NiFe-LDH/Co₃O₄) disclosed in the invention, the combination of two-dimensional nanosheets NiFe-LDH and one-dimensional Co₃O₄ nanowires can increase the specific surface area and expand the light response area, which is more conducive to the adsorption of pollutants and the absorption and utilization of light.

4. In the P—N heterojunction in the P—N heterojunction catalyst composite material supported on the surface of nickel foam (Ni foam@NiFe-LDH/Co₃O₄) disclosed in the invention, Co₃O₄ is a one-dimensional structure, which can enhance the electron transport capacity of the material.

5. The P—N heterojunction in the P—N heterojunction catalyst composite material supported on the surface of nickel foam (Ni foam@NiFe-LDH/Co₃O₄) disclosed in the invention has stable structure, simple preparation method and simple and rapid reuse. Therefore, the material prepared in the invention is simple and easy to obtain, and can effectively use the light source to purify the pollutants in the water body through photocatalysis, which is conducive to its further popularization and application.

### BRIEF DESCRIPTION OF THE DRAWINGS

FIG. 1 is a scanning electron microscope diagram of layered nickel-iron bimetallic hydroxide nanosheet supported on the surface of nickel foam (Ni foam@NiFe-LDH).

FIG. 2 is a scanning electron microscope diagram of the P—N heterojunction catalyst composite material supported on the surface of nickel foam (Ni foam@NiFe-LDH/Co₃O₄-2) in embodiment 4.

FIG. 3 is an effect diagram of removal of pollutants by photoelectric catalysis with the P—N heterojunction catalyst composite material supported on the surface of nickel foam (Ni foam@NiFe-LDH/Co₃O₄-2) in embodiment 4.

FIG. 4 is comparison of pollutant removal effects by photocatalysis, electrocatalysis and photocatalysis with the P—N heterojunction catalyst composite material supported on the surface of nickel foam (Ni foam@NiFe-LDH/Co₃O₄-2) in embodiment 4.

### DETAILED DESCRIPTION OF THE INVENTION

The preparation method of the P—N heterojunction composite material supported on the surface of nickel foam (Ni foam@NiFe-LDH/Co₃O₄) disclosed in the invention is, modifying one-dimensional cobalt oxide nanowires on the surface of the layered nickel-iron bimetallic hydroxide nanosheet supported on the surface of nickel foam by means of a mixed solvent-thermal method to obtain the P—N heterojunction composite material supported on the surface of nickel foam(Ni foam@NiFe-LDH/Co₃O₄), which can be used as catalyst.

### Embodiment 1

Preparation of the NiFe-LDH precursor solution.

0.6979 g Ni(NO₃)₂.6H₂O, 0.4803 g Fe(NO₃)₃.9H₂O and 0.8647 g urea are dissolved in 15 ml deionized water in a round bottom flask under ultrasound, then the mixture are refluxed at 100° C. under stirring for 24 h to obtain the NiFe-LDH precursor solution. The molar ratio of Ni²⁺ and Fe³⁺ in the precursor solution is 1:2, the molar concentration of Fe³⁺ is 0.1 mol/L, and the molar ratio of urea and metal ion is 4 times.

### Embodiment 2

Preparation of Ni foam@NiFe-LDH by a hydrothermal method.

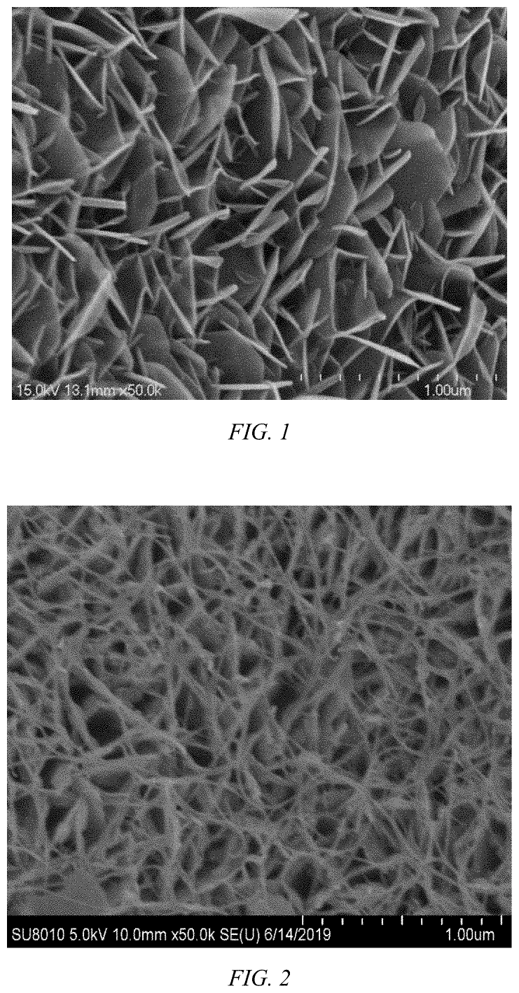

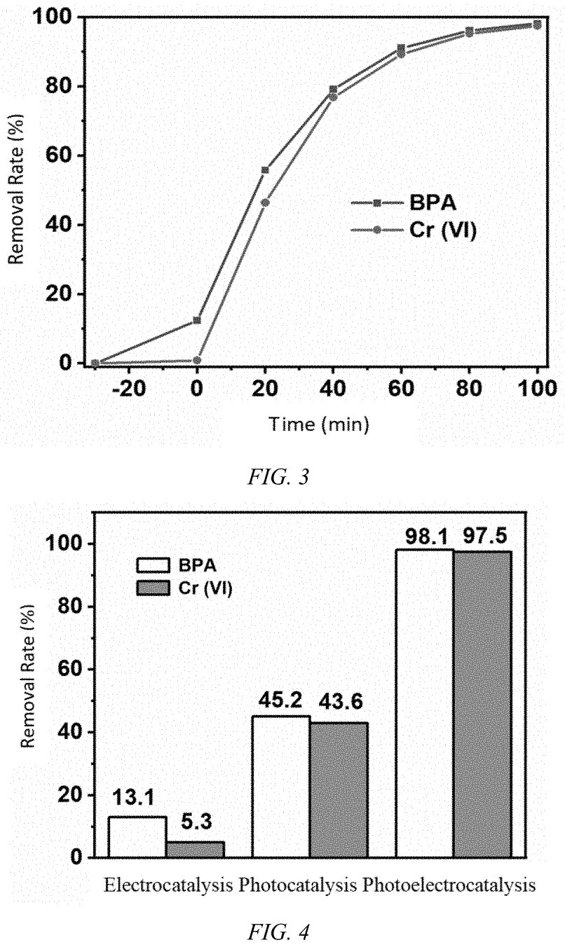

Ni foam@NiFe-LDH is obtained by a hydrothermal method. Typically, 3 ml the precursor solution of NiFe-LDH in Embodiment 1, 32 ml deionized water and the pretreated Ni foam are transferred to a Teflon-lined stainless steel autoclave and kept in an oven at 160° C. for 24 h. After the reaction is cooled to room temperature, the Ni foam@NiFe-LDH is wash 3 times with water and ethanol, and then dried under vacuum at 60° C. for 24 h. As can be seen from FIG. 1, the SEM image shows that NiFe-LDH nanosheets are evenly distributed on the smooth surface of Ni foam, which is used as photocatalyst in Embodiment 7 to treat Cr(VI). After 100 min, the removal rate of Cr(VI) is 22.3%.

### Embodiment 3

Preparation of Ni foam@NiFe-LDH/Co₃O₄-1 by meas of a mixed solvothermal method.

Preparation of Ni foam@NiFe-LDH/Co₃O₄-1 is obtained by a mixed solvothermal strategy. In a typical experiment, 0.87 g of Co(NO₃)₂.6H2_{O and} 0.72 g of urea are dissolved in 80 mL of mixed solvents of deionized water and ethanol (V_{deionized water}: Vₑₜₕₐₙₒₗ=1:1) to form a pink solution. The above solutions (10 ml the above pink solution and 25 ml the above mixed solvents) and Ni foam@NiFe-LDH obtained in Embodiment 2 are then transferred into a Teflon-lined stainless steel autoclave and kept in an oven at 90° C. for 8 h. After reaction, the product is washed 3 times by deionized water, and annealed at 250° C. for 2 h in Ar flow to obtain Ni foam@NiFe-LDH/Co₃O₄-1. A few Co₃O₄ nanowires appeared on the surface of the NiFe-LDH nanosheets after the second step in-situ growth. Ni foam@NiFe-LDH/Co₃O₄-1 is used as photocatalyst in Embodiment 7 to treat Cr(VI). After 100 min, the removal rate of Cr(VI) is 30.1%.

### Embodiment 4

Preparation of Ni foam@NiFe-LDH/Co₃O₄-2 by a mixed solvothermal strategy.

Preparation of Ni foam@NiFe-LDH/Co₃O₄-2 is obtained by a mixed solvothermal strategy. In a typical experiment, 0.87 g of Co(NO₃)₂.6H₂O and 0.72 g of urea are dissolved in 80 mL of mixed solvents of deionized water and ethanol (V_{deionized water}: Vₑₜₕₐₙₒₗ=1: 1) to form a pink solution. The above solutions (15 ml the above pink solution and 20 ml the above mixed solvents) and Ni foam@NiFe-LDH obtained in Embodiment 2 are then transferred into a Teflon-lined stainless steel autoclave and kept in an oven at 90° C. for 8 h. After reaction, the product is washed 3 times by deionized water, and annealed at 250° C. for 2 h in Ar flow to obtain Ni foam@NiFe-LDH/Co₃O₄-2. As can be seen from FIG. 2, Co₃O₄ nanowires is uniformly loaded on the surface of the NiFe-LDH nanosheet after the second step in-situ growth.

Adjust the above insulation for 2 h at 250° C. to insulation for 2 hat 300° C., and the rest remain unchanged, to obtain Ni foam@NiFe-LDH/Co₃O₄-2-1, used as photocatalyst in Embodiment 7 to treat Cr(VI). After 100 min, the removal rate of Cr(VI) is 38.5%.

### Embodiment 5

Preparation of Ni foam@NiFe-LDH/Co₃O₄-3 by a mixed solvothermal strategy.

Preparation of Ni foam@NiFe-LDH/Co₃O₄-3 is obtained by a mixed solvothermal strategy. In a typical experiment, 0.87 g of Co(NO₃)₂.6H₂O and 0.72 g of urea are dissolved in 80 mL of mixed solvents of deionized water and ethanol (V_{deionized water}: Vₑₜₕₐₙₒₗ=1: 1) to form a pink solution. The above solutions (20 ml the above pink solution and 15 ml the above mixed solvents) and Ni foam@NiFe-LDH obtained in Embodiment 2 are then transferred into a Teflon-lined stainless steel autoclave and kept in an oven at 90° C. for 8 h. After reaction, the product is washed 3 times by deionized water, and annealed at 250° C. for 2 h in Ar flow to obtain Ni foam@NiFe-LDH/Co₃O₄-3. As the increase of Co₃O₄ precursors, the surface of Ni foam@NiFe-LDH/Co₃O₄-3 is completely covered by Co₃O₄ nanowires. Ni foam@NiFe-LDH/Co₃O₄-3 is used as photocatalyst in Embodiment 7 to treat Cr(VI). After 100 min, the removal rate of Cr(VI) is 36.7%.

### Embodiment 6

Preparation of Ni foam@Co₃O₄ by a mixed solvothermal strategy.

Preparation of Ni foam@Co₃O₄ is obtained by a mixed solvothermal strategy. In a typical experiment, 0.87 g of Co(NO₃)₂.6H₂O and 0.72 g of urea are dissolved in 80 mL of mixed solvents of deionized water and ethanol (V_{deionized water}: Vₑₜₕₐₙₒₗ=1: 1) to form a pink solution. 35 ml the above pink solution and Ni foam are then transferred into a Teflon-lined stainless steel autoclave and kept in an oven at 90° C. for 8 h. After reaction, the product is washed 3 times by deionized water, and annealed at 250° C. for 2 h in Ar flow to obtain Ni foam@Co₃O₄. After SEM characterization, the surface of Ni foam is completely covered by Co₃O₄ nanowires. Ni foam@Co₃O₄ is used as photocatalyst in Embodiment 7 to treat Cr(VI). After 100 min, the removal rate of Cr(VI) is 31.3%.

### Embodiment 7

The photocatalytic experiment of Ni foam@NiFe-LDH/Co₃O₄-2 evaluated by removal of Cr(VI).

The photocatalytic experiments are performed under light irradiated with a Xenon lamp (300 W). Ni foam@NiFe-LDH/Co₃O₄-2 is added into the 50 mL solution of Cr(VI) (10 mg/L) and stirred in dark for 30 min to achieve absorption-desorption equilibrium. And then the suspension is irradiated by a 300 W Xenon lamp source (with a light filter>420 nm) and 3 mL suspension is collected and centrifuged every 20 min to analyze the concentration of Cr(VI). And the concentration of residual Cr(VI) in each period is measured by UV-vis (540 nm) with its working curve. As can be seen from FIG. 4, Ni foam@NiFe-LDH/Co₃O₄-2 shows 43.6% removal rate after 100 min through photocatalytic process.

### Embodiment 8

The photocatalytic experiment of Ni foam@NiFe-LDH/Co₃O₄-2 evaluated by removal of BPA.

The photocatalytic experiments are performed under light irradiated with a Xenon lamp (300 W). Ni foam@NiFe-LDH/Co₃O₄-2 is added into the 50 mL solution of BPA (10 mg/L) and stirred in dark for 30 min to achieve absorption-desorption equilibrium. And then the suspension is irradiated by a 300 W Xenon lamp source (with a light filter>420 nm) and 3 mL suspension is collected and centrifuged every 20 min to analyze the concentration of BPA. And the concentration of residual BPA in each period is measured by HPLC. As can be seen from FIG. 4, Ni foam@NiFe-LDH/Co₃O₄-2 shows 45.2% removal rate after 100 min through photocatalytic process.

### Embodiment 9

The electrocatalytic experiment of Ni foam@NiFe-LDH/Co₃O₄-2 evaluated by removal of BPA and Cr(VI).

The electrocatalytic experiments are performed on CHI660E in dark. The solutions of BPA and Cr(VI) are transferred to a double-chamber photoelectrochemical reaction cell separated by a nafion membrane. Ni foam@NiFe-LDH/Co₃O₄-2 is used as the working electrode, the platinum (Pt) wire, Ag/AgCl and 0.1 M Na₂SO₄ are used as counter, reference electrodes and electrolyte, respectively. Ni foam@NiFe-LDH/Co₃O₄-2 is added into the solution of BPA and stirred in dark for 30 min to achieve absorption-desorption equilibrium. And then a little voltage (such as 0.7 V) is applied by an electrochemical workstation on working electrod. 3 mL suspension is collected and centrifuged every 20 min to analyze the concentration of BPA and Cr(VI). And the concentration of residual BPA and Cr(VI) in each period is measured by HPLC and UV-vis. As can be seen from FIG. 4, after 100 min through electrocatalytic process, Ni foam@NiFe-LDH/Co₃O₄-2 shows 13.1% and 5.3% removal rate of BPA and Cr(VI).

### Embodiment 10

The photoelectrocatalytic experiment of Ni foam@NiFe-LDH/Co₃O₄-2 evaluated by removal of BPA and Cr(VI).

The photoelectrocatalytic experiments are performed on CHI660E under light irradiated with a xenon lamp (300 W). The solutions of BPA and Cr(VI) are transferred to a double-chamber photoelectrochemical reaction cell separated by a nafion membrane. Ni foam@NiFe-LDH/Co₃O₄-2 is used as the working electrode, the platinum (Pt) wire, Ag/AgCl and 0.1 M Na₂SO₄ are used as counter, reference electrodes and electrolyte, respectively. Ni foam@NiFe-LDH/Co₃O₄-2 is added into the solution of BPA and stirred in dark for 30 min to achieve absorption-desorption equilibrium. And then the suspension is irradiated by a 300 W Xenon lamp source (with a light filter>420 nm) and applied a little voltage (such as 0.7 V) by an electrochemical workstation. 3 mL suspension is collected and centrifuged every 20 min to analyze the concentration of BPA and Cr(VI). And the concentration of residual BPA and Cr(VI) in each period is measured by HPLC and UV-vis. As can be seen from FIG. 4, after 100 min through photoelectrocatalytic process, Ni foam@NiFe-LDH/Co₃O₄-2 shows 98.1% and 97.5% removal rate of BPA and Cr(VI).

The composite material disclosed by the invention has been proved to be an effective means to improve the catalytic activity of the material. For the p-n heterojunction, when two different types of semiconductors with different Fermi levels are in contact, the carriers will spontaneously flow between semiconductors until reaching the equilibrium state. At the interface of semiconductor junction, two space charge regions with opposite charges will be formed due to the flow of carriers, resulting in the corresponding built-in electric field. The built-in electric field of semiconductor junction is widely used to promote the separation of photogenerated carriers, such as solar cells and photocatalytic systems. In addition, photocatalysis technology, which enhances the catalytic activity by effectively separating the photogenerated charges generated by semiconductor materials excited by light through applied voltage, is one of the effective methods to realize the efficient utilization of solar energy, and is expected to solve the current environmental problems and energy crisis.

What we claim is:

1. A P—N heterojunction composite material supported on the surface of nickel foam, which is characterized in that the preparation method of the P—N heterojunction composite material supported on the surface of nickel foam comprising the following steps: modifying one-dimensional cobalt oxide nanowires on the surface of the layered nickel-iron bimetallic hydroxide nanosheet supported on the surface of nickel foam by means of a mixed solvent-thermal method to obtain the P—N heterojunction composite material supported on the surface of nickel foam.

2. The P—N heterojunction composite material supported on the surface of nickel foam according to claim 1, wherein using nickel foam as the supporter, modifying layered nickel-iron bimetallic hydroxide nanosheet on the surface of nickel foam by means of a hydrothermal method, and then modifying one-dimensional cobalt oxide nanowires on the surface of the layered nickel-iron bimetallic hydroxide nanosheet by means of a mixed solvent-thermal method to obtain a P—N heterojunction composite material supported on the surface of nickel foam.

3. The P—N heterojunction composite material supported on the surface of nickel foam according to claim 2, wherein mixing the precursor solution with nickel foam and then reacting at 120-180° C. for 20-30 h by means of hydrothermal reaction method to obtain the layered nickel-iron bimetallic hydroxide nanosheet supported on the surface of nickel foam; the precursor solution consists of nickel salt, iron salt, water and urea.

4. The P—N heterojunction composite material supported on the surface of nickel foam according to claim 3, wherein in the precursor solution, the molar ratio of divalent metal ion Ni²⁺ to trivalent metal ion Fe³⁺ is 2:1, and the molar number of urea is 3.8-4.2 times of the sum of the molar numbers of divalent metal ion Ni²⁺ and trivalent metal ion Fe³⁺.

5. The P—N heterojunction composite material supported on the surface of nickel foam according to claim 1, wherein mixing the layered nickel-iron bimetallic hydroxide nanosheet with cobalt containing solution, and then hydrothermal reacting at 80-100° C. for 6-10 h and then heat treating to obtain the layered nickel-iron bimetallic hydroxide nanosheet supported on the surface of nickel foam, the cobalt containing solution is composed of water, ethanol, cobalt salt and urea.

6. The P—N heterojunction composite material supported on the surface of nickel foam according to claim 5, wherein volume ratio of water to ethanol is 1:1 and molar ratio of urea to cobalt salt is 4:1, the concentration of cobalt salt is 0.003-0.008 g/mL.

7. The P—N heterojunction composite material supported on the surface of nickel foam according to claim 5, wherein heat treatment is to keep temperature at 250° C. for 1.5-2.5 h in air.

8. A method for catalytic purification of pollutants in water bodies, comprising the following steps: modifying one-dimensional cobalt oxide nanowires on the surface of the layered nickel-iron bimetallic hydroxide nanosheet supported on the surface of nickel foam by means of a mixed solvent-thermal method to obtain the P—N heterojunction composite material supported on the surface of nickel foam; adding the P—N heterojunction composite material supported on the surface of nickel foam into water containing pollutants, and performing photocatalytic and/or electrocatalysis to complete the purification of pollutants in the water.

9. A preparation method of P—N heterojunction composite material supported on the surface of nickel foam, comprising the following steps, modifying one-dimensional cobalt oxide nanowires on the surface of the layered nickel-iron bimetallic hydroxide nanosheet supported on the surface of nickel foam by means of a mixed solvent-thermal method to obtain the P—N heterojunction composite material supported on the surface of nickel foam.

10. The application of P—N heterojunction composite material supported on the surface of nickel foam according to claim 1 in the purification of pollutants in the water as a catalyst.
